(19) United States
(12) Patent Application Publication
(10) Pub. No.: US 2013/0265510 A1
(43) Pub. Date: Oct. 10, 2013

(54) THREE-DIMENSIONAL DISPLAY DEVICE AND ACTIVE OPTICAL ELEMENT THEREOF

(71) Applicants: Chong-Yang Fang, Taichung City (TW); Yu-Hung Chang, Miaoli County (TW); Ching-Fu Hsu, Taichung City (TW); Chun-Ho Chen, Changhua County (TW); Wen-Tui Liao, Taichung City (TW)

(72) Inventors: Chong-Yang Fang, Taichung City (TW); Yu-Hung Chang, Miaoli County (TW); Ching-Fu Hsu, Taichung City (TW); Chun-Ho Chen, Changhua County (TW); Wen-Tui Liao, Taichung City (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/858,111

(22) Filed: Apr. 8, 2013

(30) Foreign Application Priority Data
Apr. 9, 2012 (TW) 101112465

(51) Int. Cl. G02B 27/22

(52) U.S. Cl. CPC G02B 27/22
USPC 349/15; 349/139

(57) ABSTRACT

A three-dimensional display device and an active optical element thereof are provided. The three-dimensional display device includes a display panel, a polarizing element, and an active optical element between the display panel and the polarizing element. The active optical element includes a first substrate, a second substrate, a first electrode structure layer disposed on the first substrate, a second electrode structure layer disposed on the second substrate and a liquid crystal layer. The first electrode structure layer includes a plurality of first electrodes, a plurality of second electrodes alternately arranged with the first electrodes, and a first insulating layer located between the first electrodes and the second electrodes. The first electrodes and the second electrodes are extended along a first direction, and a first gap is formed between two adjacent second electrodes. An area of each first electrode fills one corresponding first gap.

### CROSS-REFERENCE TO RELATED APPLICATION

This application claims the priority benefit of Taiwan application serial no. 101112465, filed on Apr. 9, 2012. The entirety of the above-mentioned patent application is hereby incorporated by reference herein and made a part of this specification.

### BACKGROUND OF THE INVENTION

1. Field of the Invention

The invention relates to a three-dimensional display device, and more particularly, to a three-dimensional display device having an active optical element.

2. Description of Related Art

Other than lightness and slimness designs, pursuing for three-dimensional images display has become another major aspect in development of display technology nowadays. In view of the appearance, the technology of three-dimensional display may be roughly categorized into two types. One is stereoscopic type three-dimensional display technology which requires a viewer to wear specially designed glasses and the other is auto-stereoscopic type three-dimensional display technology which allows the viewer to see directly with naked eyes.

Stereoscopic type three-dimensional display technology mainly functions by using a three-dimensional display device to send images with special information (for example, different polarizing properties) to the left and right eyes. Through wearing glasses, the left and right eyes may receive different images, which are combined to form a three-dimensional image. Auto-stereoscopic type three-dimensional display technology mainly functions by using technologies such as parallax barrier, lenticular screen or directional backlight, projecting images respectively to the left and right eyes, three-dimensional images are formed in viewer's brain by binocular parallax generated from images received by respective eyes of the viewer. The display panel for displaying three-dimensional images using parallax barrier technology mainly uses optical grating to control images received by respective eyes.

In stereoscopic type and auto-stereoscopic type display technologies, display with three-dimensional effect may be realized by an active optical element formed by an electrode layer including two sets of stripe electrodes (odd/even electrodes) parallel and alternately arranged with each other, an electrode layer of common electrode and a liquid crystal layer sandwiched between the two electrode layers. However, due to the restriction of the manufacturing process, gaps are required in between the odd and even electrodes parallel and alternately arranged, in order to avoid short circuits between the odd and even electrodes. In this case, the liquid crystal molecules corresponding to the gaps (i.e. the peripheries of the odd and even electrodes) within the liquid crystal layer may not an arranged in the desirable orientation, thereby generating light leakage. Based on above, when the three-dimensional images are displayed by the three-dimensional display device, three-dimensional images with poor quality may be displayed due to light leakage of the active optical element.

### SUMMARY OF THE INVENTION

The invention provides a three-dimensional display device having favorable three-dimensional image quality.

The invention provides a three-dimensional display device, including a display panel, a polarizing element, and an active optical element disposed between the display panel and the polarizing element. The active optical element is disposed on the display panel and includes a first substrate, a second substrate, a first electrode structure layer, a second electrode structure layer and a liquid crystal layer. The second substrate and the first substrate are opposed to each other in a top-bottom manner. The first electrode structure layer is disposed on the first substrate, and the first electrode structure layer includes a plurality of first electrodes, a plurality of second electrodes alternately arranged with the first electrodes, and a first insulating layer located between the first electrodes and the second electrodes, wherein the first electrodes and the second electrodes are extended along a first direction, and a first gap is formed between two adjacent second electrodes, while an area of each of the first electrodes fills one corresponding first gap. The second electrode structure layer is disposed on the second substrate. The liquid crystal layer is located between the first electrode structure layer and the second electrode structure layer.

The invention further provides an active optical element, including a first substrate, a second substrate, a first electrode structure layer, a second electrode structure layer and a liquid crystal layer. The second substrate and the first substrate are opposed to each other in a top-bottom manner. The first electrode structure layer is disposed on the first substrate, and the first electrode structure layer includes a plurality of first electrodes, a plurality of second electrodes alternately arranged with the first electrodes, and a first insulating layer located between the first electrodes and the second electrodes, wherein the first electrodes and the second electrodes are extended along a first direction, and a first gap is formed between two adjacent second electrodes, and an area of each of the first electrodes fills one corresponding first gap. The second electrode structure layer is disposed on the second substrate. The liquid crystal layer is located between the first electrode structure layer and the second electrode structure layer.

Based on above, in the three-dimensional display device and the active optical element thereof according to the embodiment of the invention, the first electrodes and the second electrodes alternately arranged are formed by two conductive layers spaced apart by the insulating layer and manufactured on the same side of the liquid crystal layer, wherein the area of each first electrode fills one corresponding first gap between two adjacent second electrodes. Therefore, when different voltages are provided to the first electrodes and the second electrodes to control the orientation of the liquid crystal molecules within the liquid crystal layer, the entire liquid crystal layer is driven by the electrodes accordingly. When the three-dimensional display device is composed by a sequential arrangement of the display panel, the active optical element and the polarizing element, polarizing property of the displaying light may be controlled by the active optical element, allowing the displaying light to or not to pass through the polarizing element, thereby forming a transmission area and a barrier area. According to the embodiment of the invention, the transmission area and the barrier area of the active optical element are closely adjacent to each other. Therefore, light leakage between the transmission area and the barrier area may be avoided. Further, according to the embodiment of the invention, the barrier area may be larger than the transmission area in the active optical element by driving of the first electrodes and the second electrodes, such that crosstalk from the images received by the left and right eyes may be prevented accordingly and quality of the three-dimensional images may be improved.

In order to make the aforementioned and other features and advantages of the invention more comprehensible, embodiments accompanying drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a three-dimensional display device according to an embodiment of the invention.

FIG. 2 is a schematic view of the electrode structure layers of an active optical element according to an embodiment of the invention.

FIG. 3A and FIG. 3B are cross-sectional views of the active optical element taken along a line A-A′ of FIG. 2 during different time sequences.

FIG. 4 is a schematic view of the electrode structure layers of an active optical element according to another embodiment of the invention.

FIG. 5 is a top view of an active optical element according to another embodiment of the invention.

FIG. 6A and FIG. 6B are cross-sectional views of the active optical element taken along a line A-A′ of FIG. 5 during different time sequences.

FIG. 7A and FIG. 7B are cross-sectional views of a three-dimensional display device during different time sequences according to yet another embodiment of the invention.

FIG. 8A and FIG. 8B are cross-sectional views of a three-dimensional display device during different time sequences according to still another embodiment of the invention.

### DESCRIPTION OF THE EMBODIMENTS

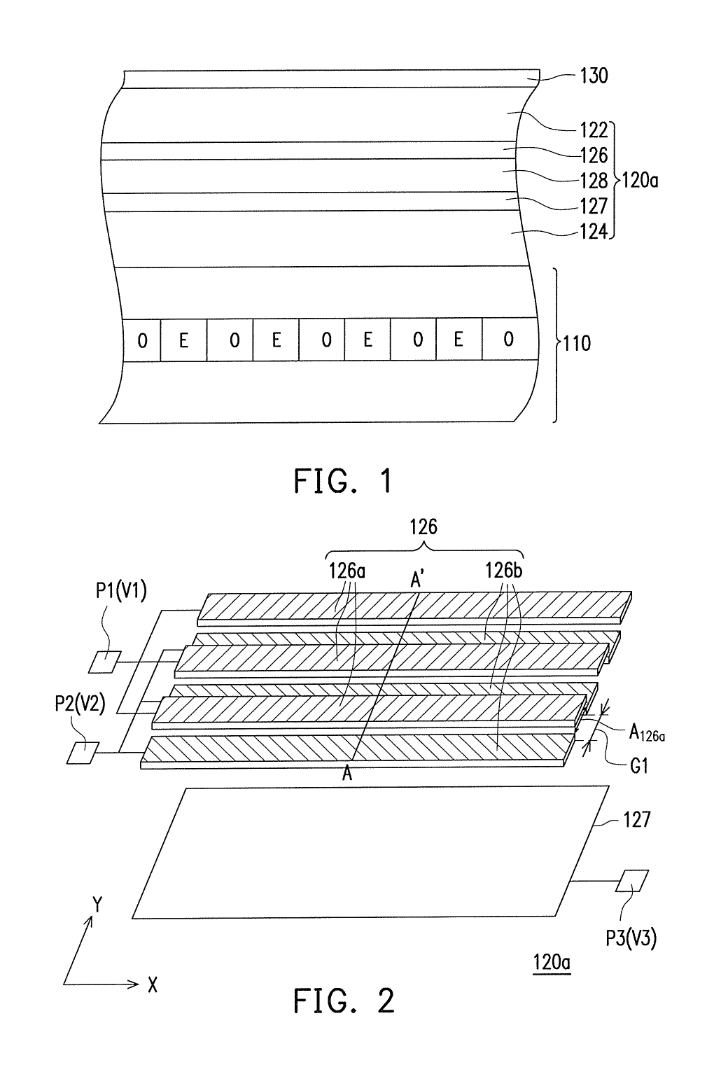

FIG. 1 is a cross-sectional view of a three-dimensional display device according to an embodiment of the invention. Referring to FIG. 1, a three-dimensional display device 100 of the present embodiment includes a display panel 110, an active optical element 120a and a polarizing element 130, wherein the active optical element 120a is disposed on the display panel 110, and the active optical element 120a is disposed between the display panel 110 and the polarizing element 130. The display panel 110 includes a plurality of odd pixels O and a plurality of even pixels E, which are arranged alternately.

The display panel 110 of present embodiment, for example, is a liquid crystal display panel that may emit a polarized light with specific polarizing property, but the present embodiment is not limited thereto. In other embodiments, the display panel 110 may also be any display panel for displaying images with a polarizer disposed on the light emitting surface thereof for emitting the polarized light with specific polarizing property, wherein the display panel for displaying images may be, for example, an organic electro-luminescence display panel, an electrophoretic display panel, a plasma display panel, an electrowetting display panel, a field emission display panel or other display panels.

Further, the active optical element 120a may, for example, change the polarizing property of the polarized light emitted from the display panel 110. In this case, the polarizing element 130 is disposed between the three-dimensional device 100 and the viewer. The polarizing element 130 is suitable for allowing light with particular polarizing property to pass through, such that the three-dimensional device 100 may have the three-dimensional display effect.

Specifically, the active optical element 120a includes a first substrate 122, a second substrate 124, a first electrode structure layer 126, a second electrode structure layer 127 and a liquid crystal layer 128. The second substrate 124 and the first substrate 122 are opposed to each other in a top-bottom manner. In the present embodiment, the first substrate 122 and the second substrate 124 may be respectively a transparent substrate, and the material thereof may be, for example, glass, quartz, organic polymer or other suitable materials. The first electrode structure layer 126 and the second electrode structure layer 127 are respectively disposed on the first substrate 122 and the second substrate 124, and respectively located at the inner sides of the first substrate 122 and the second substrate 124 where are adjacent to the liquid crystal layer 128. In addition, the first electrode structure layer 126 and the second electrode structure layer 127 respectively include a plurality of electrodes, and the material of the electrodes includes transparent conducting materials, for example, metal oxides such as indium tin oxide (ITO), indium zinc oxide (IZO), aluminum tin oxide (ATO), aluminum zinc oxide (AZO), indium germanium zinc oxide (IGZO), any other suitable materials, or a stacking layer of at least two materials listed above. The liquid crystal layer 128 is located between the first electrode structure layer 126 and the second electrode layer 127.

FIG. 2 is a schematic view of the electrode structure layers of an active optical element 120a according to an embodiment of the invention. In order to clearly illustrate the relationship between the electrode structure layers in the active optical element 120a, the first substrate 122, the second substrate 124 and the liquid crystal layer 128 are omitted in FIG. 2.

Referring to FIG. 2, the first electrode structure layer 126 includes a plurality of first electrodes 126a, a plurality of second electrodes 126b alternately arranged with the first electrodes 126a, and a first insulating layer (not illustrated), located between the first electrodes 126a and the second electrodes 126b, wherein the first electrodes 126a and the second electrodes 126b are both stripe electrodes extended along a first direction X, and the first electrodes 126a and the second electrodes 126b are arranged alternately along a second direction Y intersected with the first direction X. In addition, the first electrodes 126a, the second electrodes 126b and the second electrode structure layer 127 are electrically connected to the corresponding input pads P1, P2 and P3, respectively. It is noted that, the second electrode structure layer 127 of the present embodiment has a single layer structure, but the invention is not limited thereto. In other embodiments, the second electrode structure layer 127 may also be a dual layers electrode structure.

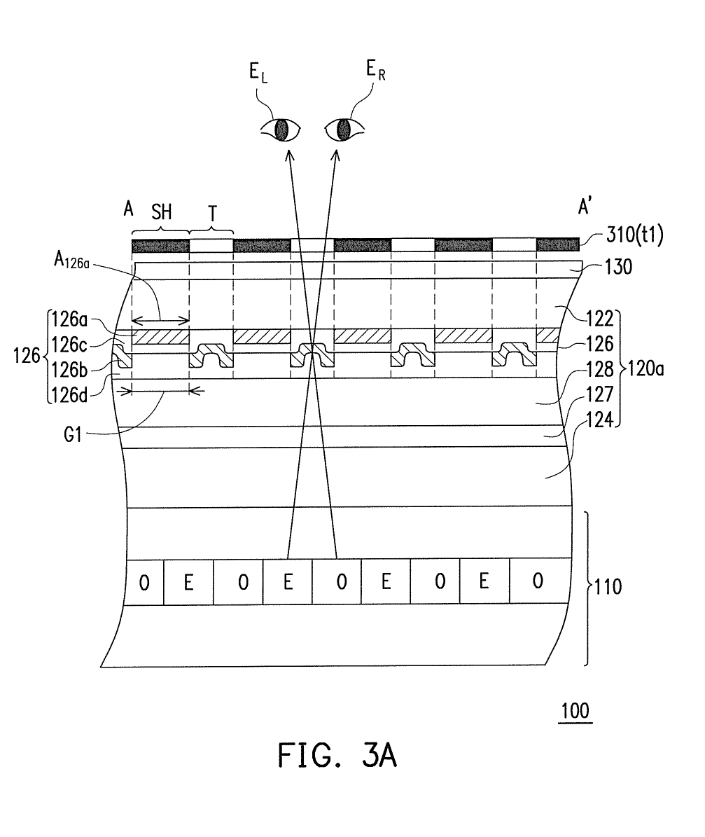

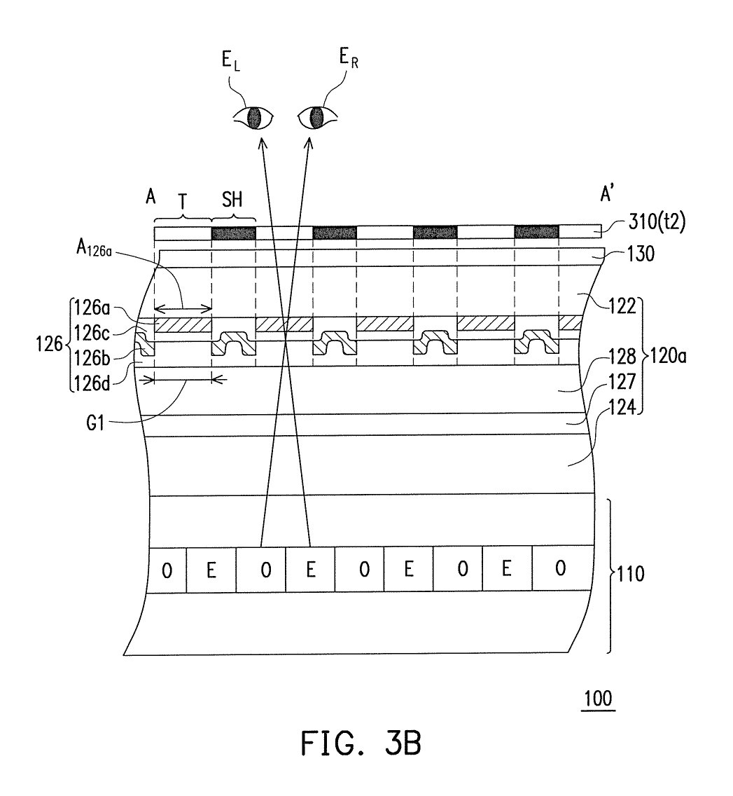

FIG. 3A and FIG. 3B are cross-sectional views of a three-dimensional display device according to an embodiment of the invention, corresponding to a line A-A′ of FIG. 2 during different time sequences. In order to facilitate the illustration of the operating principle of the three-dimensional device 100, some components within the display panel 110 are omitted in FIG. 3A and FIG. 3B. Detail description is described in FIG. 1, it will not be described herein. It is noted that, the odd pixels O and the even pixels E in FIG. 3A are illustrative only; the present embodiment is not intended to limit the arrangements of the pixels which each electrode (for example, the first electrode 126a and the second electrode 126b) is corresponding to.

Referring to FIG. 3A, the first electrodes 126a and the second electrodes 126b are formed by different layers, therefore an area A₁₂₆ₐ of each first electrode 126a may be larger than or equal to a first gap G1 between two adjacent second electrodes 126b. In the present embodiment, it is exemplified that the area A₁₂₆ₐ of each first electrode 126a is equal to the first gap G1 between two adjacent second electrodes 126b, and a first insulating layer 126c is located between the first electrodes 126a and the second electrodes 126b, for electrically insulating the first electrodes 126a and the second electrodes 126b. In other words, the first electrodes 126a and the second electrodes 126b are respectively disposed on two opposite sides of the first insulating layer 126c. In addition, a dielectric layer 126d may be selectively disposed on the active optical element 120a to cover the second electrodes 126b and the first insulating layer 126c, that is, the second electrodes 126b may be sandwiched between the first insulating layer 126c and the dielectric layer 126d.

Referring to FIG. 2, FIG. 3A, and FIG. 3B, when a three-dimensional display mode is performed, the first electrodes 126a and the second electrodes 126b are, for example, respectively inputted with a first voltage V1 and a second voltage V2, which are different voltages. Meanwhile, the second electrode structure layer 127 is, for example, inputted with a common voltage. In this case, the voltage difference between the first electrodes 126a and the second electrode structure layer 127 and voltage difference between the second electrodes 126b and the second electrode structure layer 127 are different from each other. By driving the liquid crystal layer 128 as illustrated in FIG. 2 with the two different voltage differences, the displaying light from the display panel 110 passing through the active optical element 120a at the area of the first electrode 126a and the area of the second electrode 126b may have two different polarizing properties. By the configuration of the polarizing element 130, the light of two different polarizing properties may be selectively received by the two eyes of the viewer, such that a three-dimensional image may be obtained.

It should be noted that, the three-dimensional display device 100 of the present embodiment is suitable for stereoscopic type display technology and auto-stereoscopic type display technology. With auto-stereoscopic type display technology, the polarizing element 130 may be, for example, a polarizer disposed on one side of the active optical element 120a far away from the display panel 110. In the present embodiment, the polarizing element 130 (polarizer) may be, for example, attached on the active optical element 120a, and the polarizing element 130 (polarizer) has a light transmission axis with single orientation. For example, when a three-dimensional display mode is performed, the driving method of the three-dimensional display device 100 may be divided into two continuing time sequences (as shown in FIG. 3A and FIG. 3B). During a first time sequence t1 as shown in FIG. 3A, the first voltage V1 is equal to a dark state voltage, and the second voltage V2 is, for example, a bright state voltage. During a second time sequence t2 as shown in FIG. 3B, the second voltage V2 is equal to a dark state voltage, and the first voltage V1 is, for example, a bright state voltage. It should be noted that, regardless of during the first time sequence t1 or during the second time sequence t2, the second electrode structure layer 127 is, for example, inputted with the common voltage, as to provide the required voltage difference for driving the liquid crystal layer 128.

Herein, so-called “dark state voltage” refers to voltage value that drives the liquid crystal layer 128 to provide a specific optical effect, so the displaying light passing through the liquid crystal layer 128 may not substantially pass through the polarizing element 130. Further, the “bright state voltage” refers to voltage value that drives the liquid crystal layer 128 to provide another specific optical effect, so the displaying light passing through the liquid crystal layer 128 may pass through the polarizing element 130. Therefore, as shown in FIG. 2 and FIG. 3A, during the first time sequence t1, the odd pixels O and the even pixels E respectively display the image information for the left eye E_{L} and the image information for the right eye E_{R}. Furthermore, during the first time sequence t1, the first voltage V1 inputted by the input pad P1 is the dark state voltage, therefore the area corresponding to the first electrode 126a is in a state of low-transmission, such that an opaque barrier area SH is formed on the transmission distribution schematic diagram 310. Meanwhile (during the first time sequence t1), the second voltage V2 inputted by the input pad P2 is the bright state voltage, therefore the area corresponding to the second electrode 126b is in a state of high-transmission, such that a transmission area T is formed on the transmission distribution schematic diagram 310.

In the present embodiment, during the first time sequence t1, the odd pixels O and the even pixels E respectively display the image information for the left eye E_{L} and the image information for the right eye E_{R}. Based on the distribution of the transmission area T and the barrier area SH, the image information for the left eye E_{L} displayed by the odd pixels O may be transmitted to the left eye E_{L} of the viewer, and the image information for the right eye E_{R} displayed by the even pixels E may be transmitted to the right eye E_{R} of the viewer.

Next, during the second time sequence t2, referring to FIG. 2 and FIG. 3B, the odd pixels O and the even pixels E of the display panel 110, for example, respectively display the image information for the right eye E_{R} and the image information for the left eye E_{L}. In this case (during the second time sequence t2), the first voltage V1 inputted by the input pad P1 is changed as the bright state voltage, therefore the area corresponding to the first electrode 126a is changed from the opaque barrier area SH to the transmission area T in the transmission distribution schematic diagram 310. Meanwhile (during the second time sequence t2), the second voltage V2 inputted by the input pad P2 is changed as the dark state voltage, therefore the area corresponding to the second voltage 126b is changed from the transmission area T to the opaque barrier area SH in the transmission distribution schematic diagram 310. Such that, during the second time sequence t2, based on the distribution of the transmission area T and the barrier area SH, the image information for the left eye E_{L} displayed by the even pixels E may be received by the left eye E_{L} of the viewer, and the image information for the right eye E_{R} displayed by the odd pixels O may be received by the right eye E_{R} of the viewer.

By the display method including the above two time sequences, resolution of the displaying images received by the left eye E_{L} and the right eye E_{R} of the viewer is approximately equal to resolution of displaying images displayed by the display panel 110. Therefore, resolution of the three-dimensional images displayed by the three-dimensional display device 100 of the present embodiment may be improved by using the display method of the first time sequence t1 and the second time sequence t2 (for example, improving resolution of the display images so it is equal to resolution of the display panel 110).

The switching speed of the image information of the left eye E_{L} and the image information of the right eye E_{R} may also be referred as “frame rate”. During the first time sequence t1, the image information displayed by the odd pixels O may be received by the left eye E_{L} of the viewer, and the image information displayed by the even pixels E may be received by the right eye E_{R}. During the second time sequence t2, the image information displayed by the even pixels E may be received by the left eye E_{L}, and the image information displayed by the odd pixels O may be received by the right eye E_{R}. Generally, persistence of vision of human eyes may remain for approximately 1/60 second. To avoid the left eye E_{L} and the right eye E_{R} from noticing the image information being discontinued during the first time sequence t1 and the second time sequence t2, the frame rate (or switching speed) of the three-dimensional display device 100 is preferably 120 Hz or higher, in order to obtain images with complete resolution (that is, equal to resolution of the display panel) and good displaying quality.

Further, in the active optical element 120a of the embodiment, the first electrodes 126a and the second electrodes 126b alternately arranged and manufactured on the same side of the liquid crystal layer 128 may be formed by using two conductive layers spaced apart by the insulating layer 126c. Therefore, no gaps are required between the first electrodes 126a and the second electrodes 126b (which are arranged alternately), in order to avoid short circuits between the first electrodes 126a and the second electrodes 126b. In other words, the area A₁₂₆ₐ of the first electrode 126a may completely fill/shields one first gap G1 between the corresponding two adjacent second electrodes 126b.

When different voltages are provided to the first electrodes 126a and the second electrodes 126b to control the orientation of the liquid crystal molecules within the liquid crystal layer 128, the entire liquid crystal layer 128 is driven by the electrodes accordingly. In this case, the transmission area T and the barrier area SH defined by the active optical element 120a are closely adjacent to each other without a gap therebetween, so as to avoid light leakage at the first gap G1 between two adjacent second electrodes 126b. Such that, when a three-dimensional image is displayed by the three-dimensional display device 100, since light leakage may be reduced by the active optical element 120a, quality of the three-dimensional image displayed by the three-dimensional display device 100 may be improved.

Further, the three-dimensional display device 100 of the present embodiment is also suitable for stereoscopic type display technology. The difference between stereoscopic type three-dimensional display technology and auto-stereoscopic type three-dimensional display technology lies where in stereoscopic type three-dimensional display technology, the polarizing element 130 is a polarizing glasses (not illustrated), in which the polarizing property of the left lens is different to the polarizing property of the right lens. In other words, the left lens and the right lens of the polarizing glasses may respectively refer to as a first polarizing element and a second polarizing element. In this case, the visual effect received by any of the left eye and the right eye of the viewer is the same as described above. That is, as described above, when the first electrodes 126a and the second electrodes 126b are respectively inputted with different voltages, the displaying light from the display panel 100 passing the areas of the first electrodes 126a and the second electrodes 126b of the active optical panel 130 may have two different polarizing properties. Therefore, when the viewer with the polarizing glasses watches the three-dimensional display device 100, the left eye only receives the displaying light of one polarizing property, and the right eye only receives the displaying light of another polarizing property. In other words, when light of two polarizing properties passes through the corresponding polarized lenses with different optical properties, the left and right eyes of the viewer may respectively see the left-eye image and the right-eye image having different polarized orientations, such that a three-dimensional image may be formed.

For example, the left lens of the polarizing glasses has levorotary polarizing property, whereas the right lens has dextrorotary polarizing property. Light outputted by the odd pixels O and the even pixels E of the display panel 110 has the same polarizing property (such as dextrorotary light). During the first time sequence t1, by adjusting the voltage difference between the first electrode structure layer 126 and the second electrode structure layer 127 in the active optical element 120a, the liquid crystal molecules corresponding to the areas of the first electrodes 126a or the second electrodes 126b are rearranged according to the electrical field distribution, which facilitates to change the polarizing property of the light emitted from the odd pixels O of the display panel 110, e.g. to levorotary light. Further, polarizing property of the even pixel E may remain in the same polarized orientation (i.e. dextrorotary light). Therefore, during the first time sequence t1, through the polarizing glasses, the image from the odd pixels O may be received by the left eye, and the image from the even pixels E may be received by the right eye.

During the second time sequence t2, by adjusting the active optical element 120a, the polarizing property of the light emitted from the odd pixel O may remain the same polarized orientation as the light emitted from the display panel 100 (i.e. dextrorotary light), whereas the polarizing property of the even pixel E is changed to levorotary light. Therefore, during the second time sequence t2, through the polarizing glasses, the images from the even pixels E may be received by the left eye, and the images from the odd pixels O may be received by the right eye. As such, by alternately displaying the image information for the left eye E_{L} and the right eye E_{R}, combining with the frame rate (or the switching speed) of the three-dimensional display device 100 set to 120 Hz or higher, images with complete resolution (that is, equal to resolution of the display panel) and good displaying quality may be obtained.

Of course, other than the combination of a dual layer electrode structure of the first electrode structure layer 126 and a single layer electrode structure of the second electrode structure layer 127 used in above embodiment, in other embodiments, the active optical element may also use the combination of a dual layer electrode structure of the first electrode structure layer and a dual layer electrode structure of the second electrode structure layer, or the combination of a single layer electrode structure of the first electrode structure layer and a dual layer electrode structure of the second electrode structure layer. An example below shows the combination of a dual layer electrode structure of the first electrode structure layer and a dual layer electrode structure of the second electrode structure layer.

To simplify the description, the following embodiments are illustrated using auto-stereoscopic type three-dimensional display technology only, the effects and the operating principle of the stereoscopic type three-dimensional display technology are not repeated hereinafter. However, the following embodiments are not limited only to be applied to the auto-stereoscopic type three-dimensional display technology.

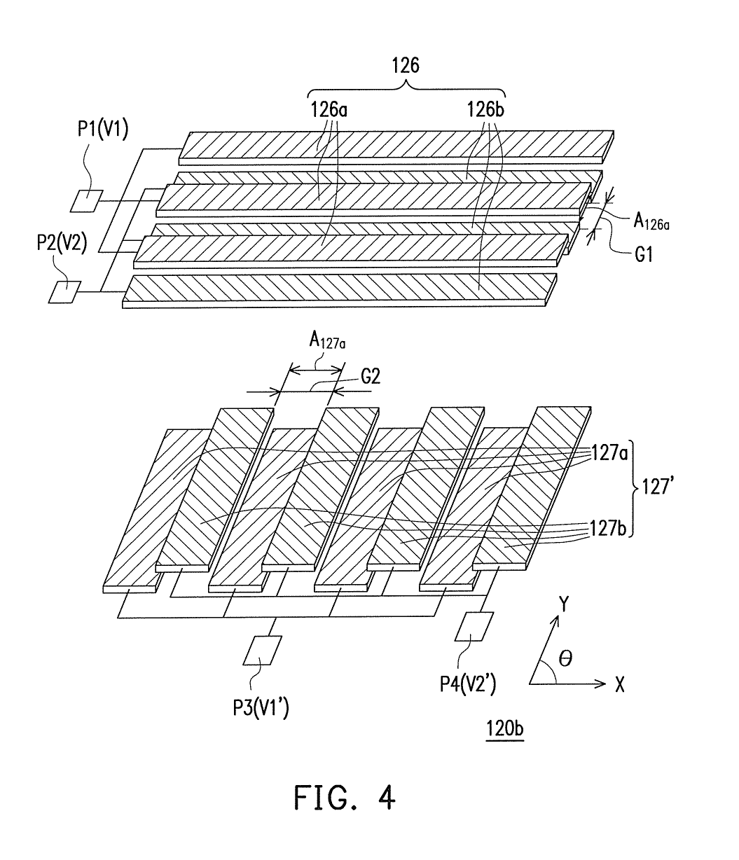

FIG. 4 is a schematic view of the electrode structure layers of an active optical element according to another embodiment of the invention. In order to clearly illustrate the relationship between the electrode structure layers in the active optical element, the first substrate 122, the second substrate 124 and the liquid crystal layer 128 are omitted in FIG. 4.

Referring to FIG. 4, the active optical element 120b of the present embodiment and the active optical element 120a of the FIG. 2 have similar structures, and similar reference numbers refer to similar compositions and effects, the only difference lies where the second electrode structure layer 127′ of the active optical element 120b is a dual layer electrode structure. Specifically, the second electrode structure layer 127′ includes a plurality of third electrodes 127a and a plurality of fourth electrodes 127b, arranged alternately with the third electrodes 127a. It is noted that, the second electrode structure layer 127′ further includes a second insulating layer (not illustrated), disposed between the third electrodes 127a and the fourth electrodes 127b. In addition, the third electrodes 127a and the fourth electrodes 127b are both stripe electrodes extended along the second direction Y intersected with the first direction X, and the third electrodes 127a and the fourth electrodes 127b are arranged alternately along the first direction X.

It is noted that, the included angle θ of the first direction X and the second direction Y is not limited to 90 degrees; instead, the included angle θ may vary depending on different requirements of the three-dimensional display devices. In addition, a second gap G2 is disposed between two adjacent fourth electrodes 127b, and an area A₁₂₇ₐ of each third electrode fills the corresponding second gap G2. Specifically, the area A₁₂₇ₐ of each third electrode 127a may be larger than or equal to the second gap G2 between two adjacent fourth electrodes 127b.

Further, when a three-dimensional display mode is performed, the third electrodes 127a and the fourth electrodes 127b are, for example, respectively inputted with a first voltage V1′ and a second voltage V2′, wherein during a first time sequence t1, one of the first voltage V1′ and the second voltage V2′ is equal to a dark state voltage, and during the second time sequence t2, the other one of the first voltage V1′ and the second voltage V2′ is equal to a dark state voltage. The first voltage V1′ and the second voltage V2′ herein may selectively be adjust based on the voltage values of the first voltage V1 and the second voltage V2 applied to the first electrodes 126a and the second electrodes 126b to control the state of the liquid crystal layer between the first electrode structure layer 126 and the second electrode structure layer 127′. Accordingly, the transmission area and the barrier area defined by the orientation of the liquid crystal layer may have an array distribution. Specifically, although the active optical element 120b of the present embodiment requires four input pads P1, P2, P3 and P4 for inputting different voltages, however, two voltages may be used in the active optical element 120b of the present embodiment to control parallax barrier of the array distribution.

Thereby, the three-dimensional display device using the active optical element 120b of the present embodiment not only has the characteristic of the three-dimensional display device 100 as described in above embodiment, but also has the transmission areas and the barrier areas with array distribution by the configurations of the first electrode structure layer 126 and the second electrode structure layer 127′ which are intersected with each other. Therefore, the active optical element 120b of the present embodiment not only suitable for display panel with the pixel array of stripe layout, but also suitable for display panel with the pixel array of dot layout or other non-stripe layouts.

In addition, since the first electrode structure layer 126 and the second electrode structure layer 127′ are intersected with each other, when a three-dimensional display is performed, whether the three-dimensional display device is placed horizontally or vertically (rotated for 90 degrees), a vertical parallax barrier may be formed by corresponding electrode layer, such that images watched from different angles may all display with the same three-dimensional effect.

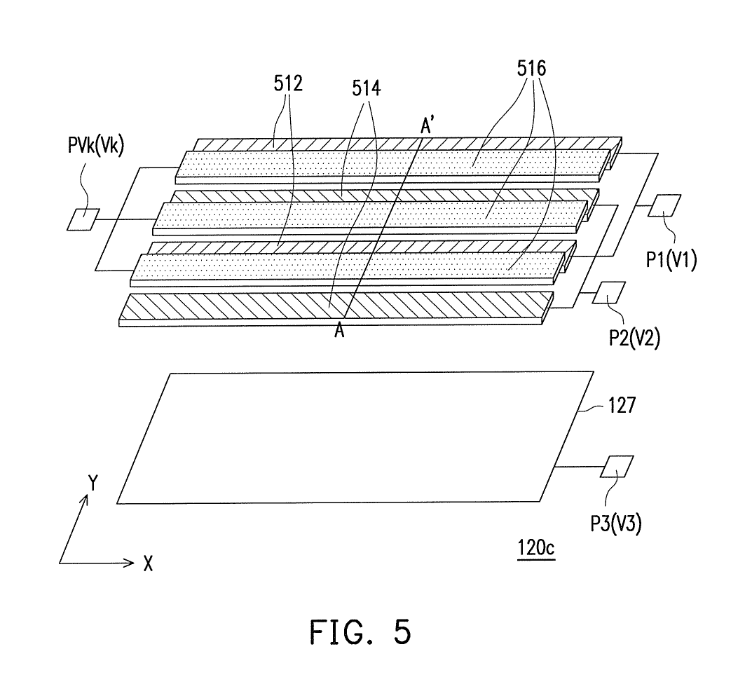

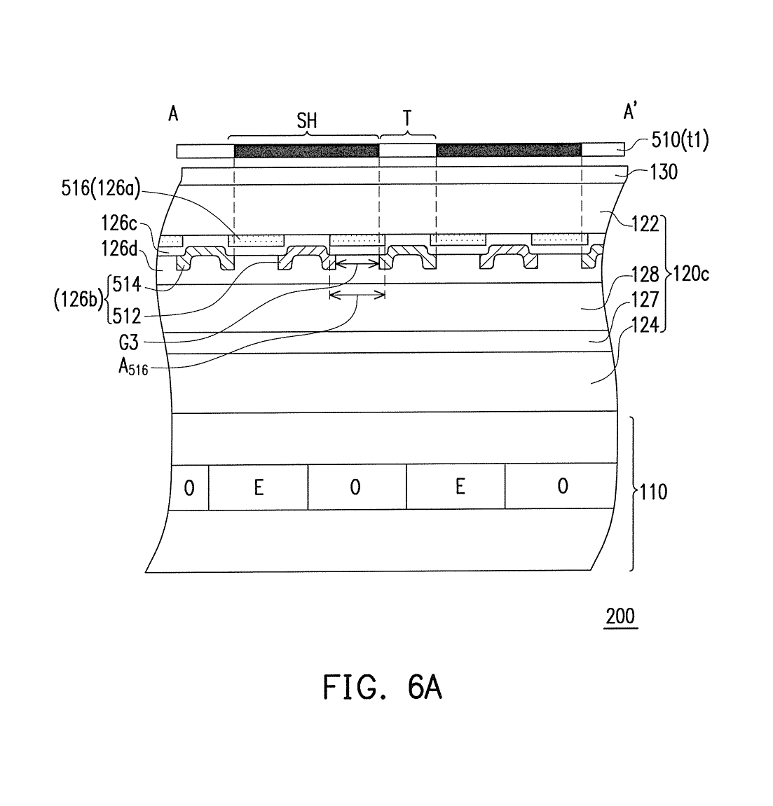

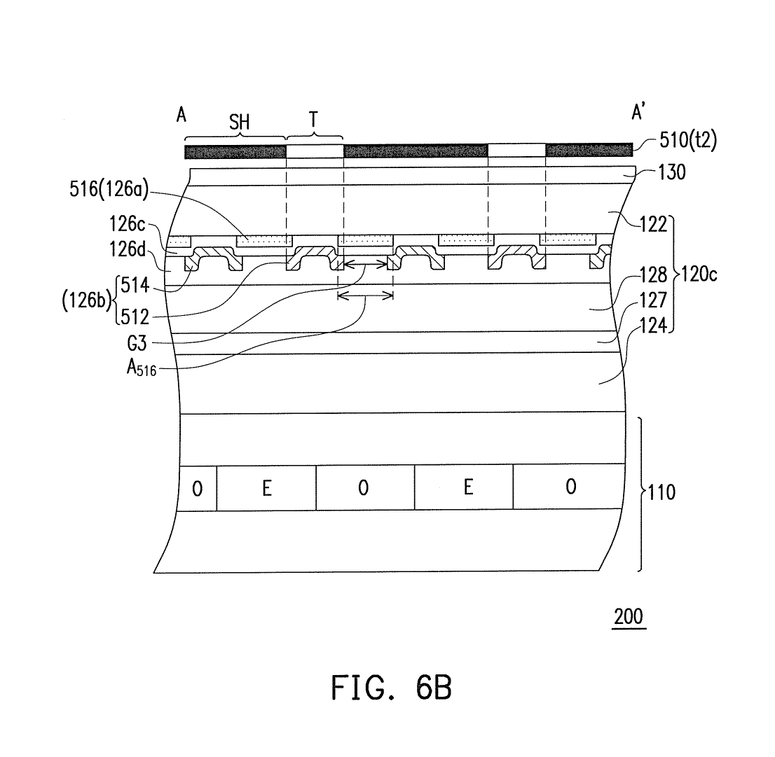

Further, other than above-said structures which may be used by the active optical element of the invention, in other embodiments, the active optical element may also have other arrangements that are suitable for displaying three-dimensional images with favorite quality, detailed method for such arrangements are described below with accompanying reference of FIG. 5, FIG. 6A and FIG. 6B. FIG. 5 is a top view of an active optical element according to another embodiment of the invention, and FIG. 6A and FIG. 6B are cross-sectional views of the active optical element depicted in FIG. 5 taken along a line A-A′ during different time sequences.

Referring to FIG. 5, FIG. 6A and FIG. 6B together, the active optical element 120c of the three-dimensional display device 200 of the present embodiment and the active optical element 120a of FIG. 3A have similar structures, and similar reference numbers refer to similar compositions and have similar effects. The difference thereof lies where in the active optical element 120c, the first electrodes 126a and the second electrodes 126b may be further divided into a plurality of dark state electrodes 516 continuously inputted with a dark state voltage Vk, a plurality of first driving electrodes 512 inputted with a first voltage V1 and a plurality of second driving electrodes 514 inputted with a second voltage V2. In other words, a portion of the first electrodes 126a and the second electrodes 126b is continuously inputted with the dark state voltage Vk and thereby referring as the dark state electrodes 516; another portion thereof is inputted with the first voltage V1 and thereby referring as the first driving electrodes 512; the remaining portion thereof is inputted with the second voltage V2 and thereby referring as the second driving electrodes 514. Herein, either the first driving electrodes 512 or the second driving electrodes 514 are disposed between two adjacent dark state electrodes 516. Further, the width design of the first electrodes 126a and the second electrodes 126b may be adjusted according the different design criteria, wherein the one continuously inputted with the dark state voltage Vk may have a narrower width, so that the active optical element 120c may have the desired transmission. In other words, the widths of the dark state electrodes 516, the first driving electrodes 512 and the second driving electrodes 514 may be the same or different.

In the present embodiment, the first electrodes 126a, for example, are a plurality of dark state electrodes 516 continuously inputted with a dark state voltage Vk, and the second electrodes 126b are divided into a plurality of first driving electrodes 512 inputted with a first voltage V1 and a plurality of second driving electrodes 514 inputted with a second voltage V2. The first driving electrodes 512 and the second driving electrodes 514 are, for example, located at the same side of the first insulating layer 126c, and arranged alternately with each other. Further, a third gap G3 is existed between adjacent two of the first driving electrode 512 and the second driving electrode 514, and an area A₅₁₆ of each dark state electrode 516 fills one corresponding third gap G3. Specifically, the area A₅₁₆ of the dark state electrode 516 may be larger or equal to the third gap G3. In this embodiment, the area A₅₁₆ of the dark state electrode 516, for example, is larger than the third gap G3, but the invention is not limited thereto. In other embodiments, the area A₅₁₆ of the dark state electrode 516 may also be equal to the third gap G3.

Referring to FIG. 5 and FIG. 6A together, when a three-dimensional display mode is performed, during the first time sequence t1, the odd pixels O and the even pixels E, for example, display image information for left eye E_{L} and the image information for right eye E_{R}, respectively. In this case (during the first time sequence t1), the first voltage V1 inputted from the input pad P1 is the dark state voltage, therefore, the areas corresponding to the first driving electrodes 512 form the opaque barrier areas SH on the transmission distribution schematic diagram 510. Meanwhile (during the first time sequence t1), the second voltage V2 inputted from the input pad P2 is the bright state voltage, therefore the areas corresponding to the second driving electrodes 514 form the transmission area T on the transmission distribution schematic diagram 510. Such that, during the first time sequence t1, the image information for the left eye E_{L} displayed by the odd pixels O may be received by the left eye E_{L} of the viewer, and the image information for the right eye E_{R} displayed by the even pixels E may be received by the right eye E_{R} of the viewer.

During the second time sequence t2, as shown in FIG. 5 and FIG. 6B, the odd pixels O and the even pixels E of the display panel 110 are respectively switched to display the image information for the right eye E_{R} and the image information for the left eye E_{L}. In this case (during the first time sequence t2), the first voltage V1 inputted from the input pad P1 is changed as the bright state voltage, the areas corresponding to the first driving electrodes 512 are changed from the opaque barrier areas SH to the transmission areas T on the transmission distribution schematic diagram 510. Meanwhile (during the second time sequence t2), the second voltage V2 outputted from the input pad P2 is switched to the dark state voltage, so the areas corresponding to the second driving voltages 514 are changed from the transmission area T to the opaque barrier area SH on the transmission distribution schematic diagram 510. Such that, during the second time sequence t2, the image information for the left eye E_{L} displayed by the even pixels E may be received by the left eye E_{L} of the viewer, and the image information for the right eye E_{R} displayed by the odd pixels O may be received by the right eye E_{R} of the viewer.

It should be noted that, the frame rate of the three-dimensional display device 200 of the present embodiment may also be raised, thereby improving quality of the display images with the same effect as having resolution of the display panel 110. Specifically, the voltages provided for the first driving electrodes 512 and the second driving electrodes 514 of the active crystal barrier 120c is switched at a frequency of 120 Hz, such that displaying with three-dimensional effect may be obtained without reduction of resolution to the displaying images.

Further, in the three-dimensional display device 200 of the present embodiment, besides that the opaque barrier areas SH may be defined by the liquid crystal molecules driven by the dark state electrode 516 continuously inputted with dark state voltage, in the case where the first voltage V1 or the second voltage V2 is the dark state voltage, further opaque barrier areas SH may also be defined by the corresponding driving electrode (i.e. the first driving electrode 512 or the second driving electrode 514). Therefore, the barrier area SH is larger than the transmission area T in the active optical element 120c, which conduces not only to avoid the light leakage at large angle, but also prevent from the crosstalk of the images received by the left and right eyes, such that quality of the three-dimensional images may be improved.

It is noted that, in the electrode pattern design of the present embodiment, the first electrodes 126a are partially overlapped with the second electrodes 126b. The electrical field provided by the first electrodes 126a in the overlapping area can not be applied directly to the liquid crystal layer 128 due to shielding of the second electrodes 126b. Therefore, although all the first electrodes 126a continuously inputted with the dark state voltage Vk are referred as the dark state electrodes 516, only the portion of the dark state electrodes 516 corresponding to the third gap G3 may effectively control the liquid crystal molecules, for defining continuously opaque barrier areas SH. In other words, transmission state or opaque state of the area where the first electrodes 126a are overlapping with the second electrodes 126b is controlled by the voltage of the second electrodes 126b instead of the voltage of the first electrodes 126a.

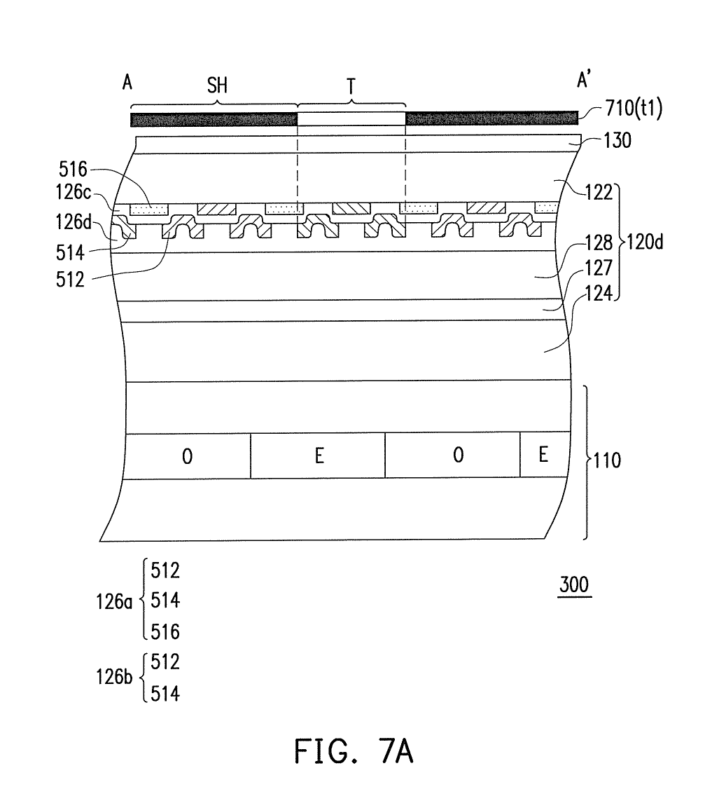

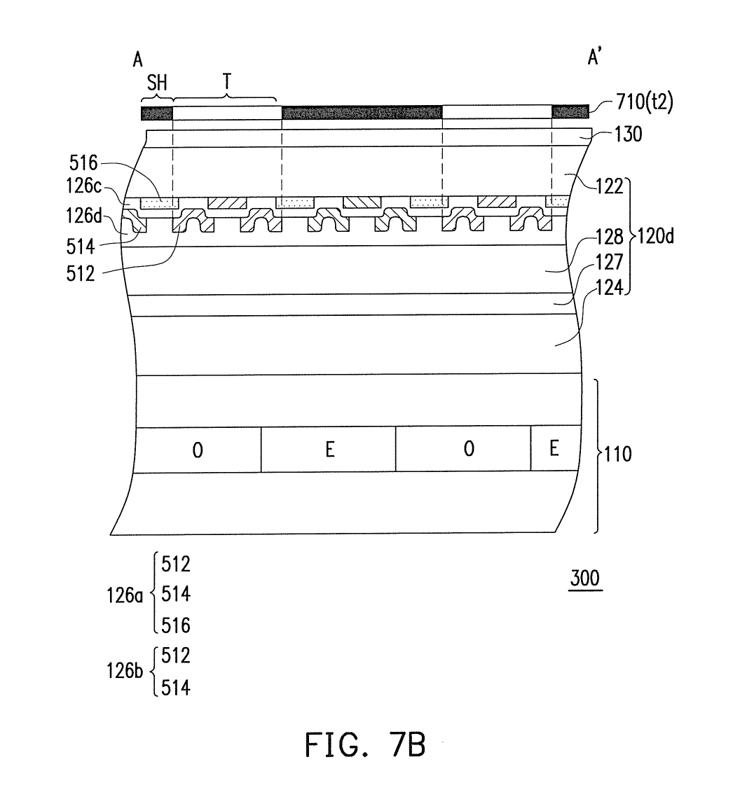

Of course, the present embodiment is not intended to limit the arrangement of the pixels corresponding to each driving electrode of the invention. For example, in the present embodiment, one driving electrode (such as one first driving electrode 512 or one second driving electrode 514) is corresponding to one pixel. However, in other embodiments, a plurality of driving electrodes (such as a plurality of driving electrodes 512 or a plurality of second driving electrodes 514) corresponding to one pixel is also possible. FIG. 7A and FIG. 7B are cross-sectional views of a three-dimensional display device during different time sequences according to yet another embodiment of the invention.

Referring to FIG. 7A, three identical electrodes (such as three first driving electrodes 512 or three second driving electrodes 514) are corresponding to one pixel in the three-dimensional display device 300 of the present embodiment. Specifically, the three-dimensional display device 300 of the present embodiment and the three-dimensional display device 200 of FIG. 6A have similar structures, and similar reference numbers refer to similar compositions and have similar effects. The difference thereof lies where in the active optical element 120d, the first electrodes 126a are divided into a plurality of dark state electrodes 516 continuously inputted with a dark state voltage Vk, a plurality of first driving electrodes 512 inputted with a first voltage V1 and a plurality of second driving electrodes 514 inputted with a second voltage V2, whereas the second electrodes 126b are divided into a plurality of first driving electrodes 512 inputted with a first voltage V1 and a plurality of second driving electrodes 514 inputted with a second voltage V2. In other words, the plurality of first electrodes 126a formed by the same conductive layer is driven by three voltages, including the dark state voltage Vk (continuously provided), the first voltage V1 and the second voltage V2. Further, the plurality of second electrodes 126b formed by the same conductive layer is driven by two voltages, including the first voltage V1 and the second voltage V2.

Specifically, FIG. 7A and FIG. 7B are schematic views of the three-dimensional display during different time sequences, the driving method of the active optical element 120d is similar to the embodiment illustrated in FIG. 6A and FIG. 6B. Which means that, during the first time sequence t1, for example, the first voltage V1 is equal to a dark state voltage for providing to the first driving electrode 512, and the second voltage V2 is equal a bright state voltage for providing to the second driving electrode 514. Meanwhile, the dark state electrode 516 is provided with the dark state voltage Vk. Accordingly, the areas corresponding to the second driving electrodes 514 may define as the transmission areas T, so that the image information for the left eye E_{L} displayed by the odd pixels O may be projected to the left eye E_{L} of the viewer, and the image information for the right eye E_{R} displayed by the even pixels E may be projected to the right eye E_{R} of the viewer. In addition, during the second time sequence t2, the first voltage V1 provided to the first driving electrode 512 is changed to the bright state voltage, and the second voltage V2 provided to the second driving electrode 514 is changed to the dark state voltage Vk. Moreover, the dark state electrode 516 is still continuously provided with the dark state voltage. Accordingly, the image information for the left eye E_{L} displayed by the even pixels E may be projected to the left eye E_{L} of the viewer, and the image information for the right eye E_{R} displayed by the odd pixels O may be projected to the right eye E_{R} of the viewer.

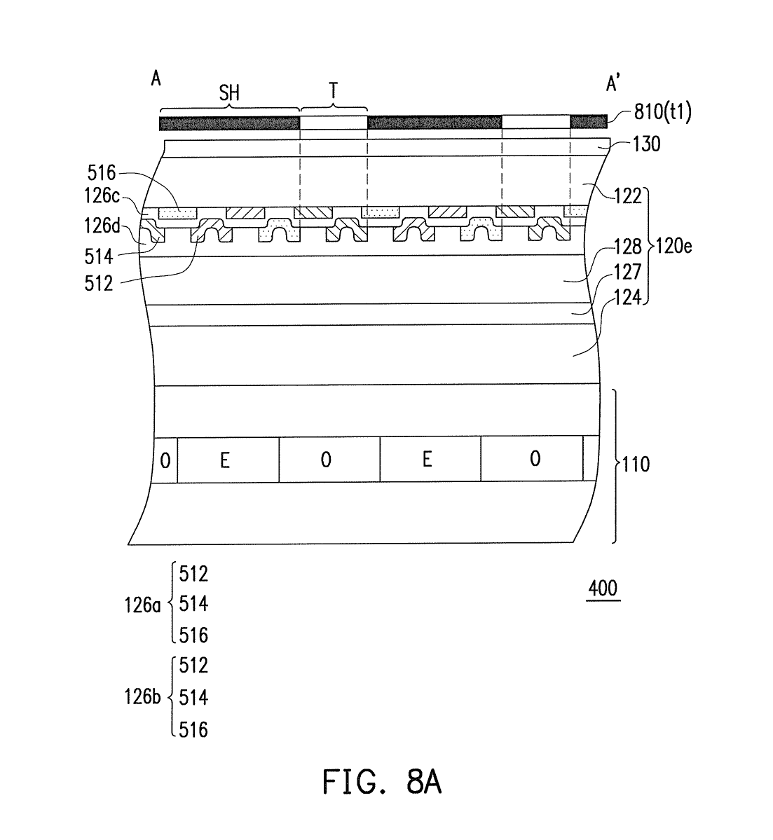

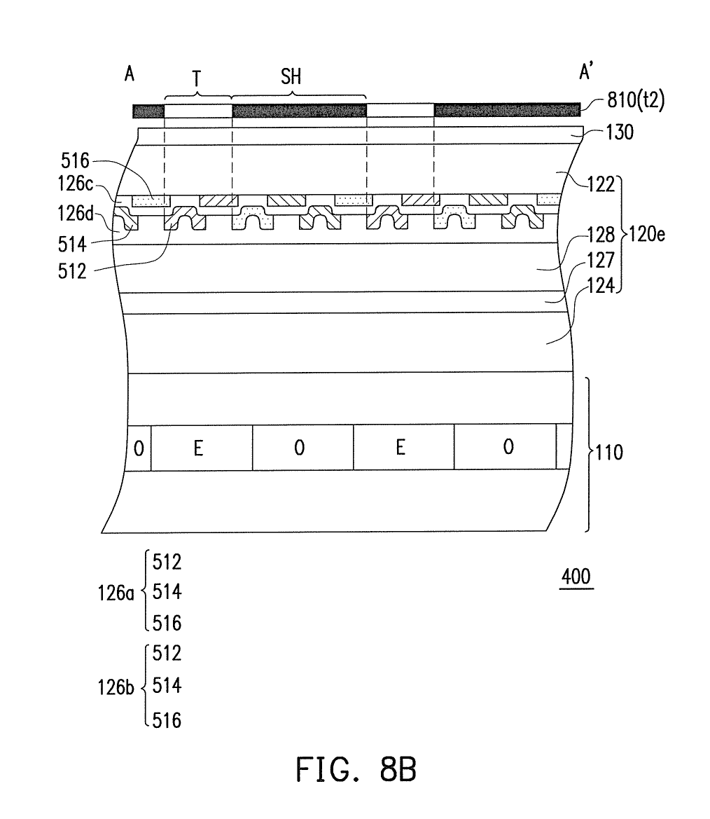

Certainly, in the above embodiments, the design that the dark state electrodes 516 continuously inputted with the dark state voltage Vk are formed by the same conductive layer is not intended to limit the invention. In other embodiments, a portion of the second electrodes may also be continuously inputted with the dark state voltage Vk, thereby referring as the dark state electrodes, as shown in FIG. 8A and FIG. 8B. FIG. 8A and FIG. 8B are cross-sectional views of a three-dimensional display device during different time sequences according to still another embodiment of the invention. Referring to FIG. 8A and FIG. 8B, three of the sequentially arranged first electrodes 126a in the three-dimensional display device 400 of the present embodiment may be served as the dark state electrodes 516, the first driving electrodes 512 and the second driving electrodes 514, according to the voltages inputted therewith. Meanwhile, three of the sequentially arranged second electrodes 126b may be served as the dark state electrodes 516, the second driving electrodes 514 and the first driving electrodes 512, according to the voltages inputted therewith. Herein, the dark state electrodes 516, the first driving electrodes 512 and the second driving electrodes 514 are respectively defined as the electrodes continuously inputted with the dark state voltage, the electrodes inputted with the first voltage and the electrodes inputted with second voltage, wherein the description related to the dark state voltage, the first voltage and the second voltage may refer to the description in the above embodiments, which is omitted hereinafter.

Specifically, the difference between the present embodiment and the embodiment shown in FIG. 7A and FIG. 7B lies where there are two driving electrodes corresponding to each pixel (the odd pixel or the even pixel), wherein the two driving electrodes are one first electrode 126a and one second electrode 126b, and the two driving electrodes are provided with the same voltage. For example, in the present embodiment, the two driving electrodes (such as the first driving electrodes 512 or the second driving electrodes 514) corresponding to an even pixel E may be the first driving electrodes 512 defined by one of the first electrode 126a inputted with the first voltage and one of the second electrode 126b inputted with the first voltage. The two driving electrodes corresponding to an odd pixel O may be, the second driving electrodes 514 defined by another of the first electrodes 126a inputted with the second voltage and another of the second electrode 126b inputted with the second voltage. Of course, the present embodiment is not limited thereto. Further, in the present embodiment, the dark state electrodes inputted with the dark state voltage, may be the second electrode 126b located at one side of the first insulating layer 126c closing to the liquid crystal layer 128, or the first electrode 126a located at the other side of the first insulating layer 126c.

It should be noted that, the three-dimensional display device 400 of the present embodiment may change the frequency of the voltages provided to the first driving electrodes 512 and the second driving electrodes 514, at a frequency of 120 Hz, and three-dimensional displaying effect may be obtained without reduction of resolution to the displaying images. Moreover, light leakage at large angle can be shielded by providing a plurality of dark state electrodes 516 to the active optical element 120e in the present embodiment.

Based on above, in the three-dimensional display device of the embodiment of the invention, the first electrodes and the second electrodes alternately arranged and manufactured on the same side of the liquid crystal layer may be formed by two conductive layers spaced apart by the insulating layer. The area of the first electrode fills the corresponding first gap between two adjacent second electrodes, thereby improving known problem of light leakage in the related art, which is caused by the liquid crystal molecules not being able to be arranged in the desired orientation at the gap between the electrodes. In other words, light leakage may be reduced by the arrangement of the active optical element in the embodiment, and quality of the three-dimensional images displayed by the three-dimensional display device may also be improved. In addition, the barrier areas and the transmission areas of array distribution may also be obtained in the active optical element of the embodiment, by the first electrode structure layer and the second electrode structure layer, which are intersected with each other. Therefore, the active optical element of the embodiment is not only suitable for display panel having the pixel array with stripe layout, but also suitable for display panel having the pixel array with dot layout or other non-stripe layouts. In addition, a vertical parallax barrier may be formed by the corresponding electrode layer, whether the three-dimensional display device is placed horizontally or vertically (rotated for 90 degrees). Further, in the three-dimensional display device according to the embodiment of invention, a plurality of dark state electrodes may also be defined by a portion of the first electrodes and/or a portion of the second electrodes continuously inputted with dark voltage. In this case, the barrier area is larger than the transmission area in the active optical element, such that crosstalk of the images received by the left and right eyes may also be further reduced, and quality of the three-dimensional images may be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional display device, comprising:
a display panel;
an active optical element, disposed on the display panel, the active optical element comprises:
a first substrate;
a second substrate, opposed to the first substrate in a top-bottom;
a first electrode structure layer, disposed on the first substrate, and the first electrode structure layer comprising a plurality of first electrodes, a plurality of second electrodes alternately arranged with the first electrodes, and a first insulating layer located between the first electrodes and the second electrodes, wherein the first electrodes and the second electrodes are extended along a first direction, and a first gap is formed between two adjacent second electrodes while an area of each of the first electrodes fills one corresponding first gap;
a second electrode structure layer, disposed on the second substrate; and
a liquid crystal layer, located between the first electrode structure layer and the second electrode structure layer.

2. The three-dimensional display device of claim 1, wherein the area of each of the first electrodes is larger than the first gap between the two adjacent second electrodes.

3. The three-dimensional display device of claim 1, wherein the area of each of the first electrodes is equal to the first gap between the two adjacent second electrodes.

4. The three-dimensional display device of claim 1, wherein when a three-dimensional display mode is performed, the first electrodes and the second electrodes are respectively inputted with a first voltage and a second voltage different from the first voltage.

5. The three-dimensional display device of claim 4, wherein during a first time sequence, one of the first voltage and the second voltage is equal to a dark state voltage, and during a second time sequence, the other one of the first voltage and the second voltage is equal to the dark state voltage.

6. The three-dimensional display device of claim 1, wherein when a three-dimensional display mode is performed, the first electrodes and the second electrodes are divided into a plurality of dark state electrodes continuously inputted with a dark state voltage, a plurality of first driving electrodes inputted with a first voltage, and a plurality of second driving electrodes inputted with a second voltage, and either the first driving electrodes or the second driving electrodes are disposed between two adjacent dark state electrodes.

7. The three-dimensional display device of claim 6, wherein during a first time sequence, one of the first voltage and the second voltage is equal to a dark state voltage, and during a second time sequence, the other one of the first voltage and the second voltage is equal to the dark state voltage.

8. The three-dimensional display device of claim 1, wherein the second electrode structure layer comprises a plurality of third electrodes, a plurality of fourth electrodes alternately arranged with the third electrodes, and a second insulating layer located between the third electrodes and the fourth electrodes, wherein the third electrodes and the fourth electrodes are extended along a second direction intersected with the first direction, and a second gap is formed between two adjacent fourth electrodes, and an area of each of the third electrodes fills one corresponding second gap.

9. The three-dimensional display device of claim 8, wherein the area of each of the third electrodes is larger than the second gap between the two adjacent fourth electrodes.

10. The three-dimensional display device of claim 8, wherein the area of each of the third electrodes is equal to the second gap between the two adjacent fourth electrodes.

11. The three-dimensional display device of claim 8, wherein when a three-dimensional display mode is performed, the third electrodes and the fourth electrodes are respectively inputted with a first voltage and a second voltage different from the first voltage.

12. The three-dimensional display device of claim 11, wherein during a first time sequence, one of the first voltage and the second voltage is equal to a dark state voltage, and during a second time sequence, the other one of the first voltage and the second voltage is equal to the dark state voltage.

13. The three-dimensional display device of claim 8, wherein when a three-dimensional display mode is performed, the third electrodes and the fourth electrodes are divided into a plurality of dark state electrodes continuously inputted with a dark state voltage, a plurality of first driving electrode inputted with a first voltage, and a plurality of second driving electrode inputted with a second voltage, and either the first driving electrodes or the second driving electrodes are disposed between two adjacent dark state electrodes.

14. The three-dimensional display device of claim 13, wherein during a first time sequence, one of the first voltage and the second voltage is equal to a dark state voltage, and during a second time sequence, the other one of the first voltage and the second voltage is equal to the dark state voltage.

15. The three-dimensional display device of claim 1, further comprising a polarizing element, the active optical element being disposed between the display panel and the polarizing element.

16. The three-dimensional display device of claim 15, wherein the polarizing element is attached on the active optical element.

17. The three-dimensional display device of claim 15, wherein the polarizing element is a polarizing glasses having a first polarizing lens and a second polarizing lens, wherein the polarizing properties of the first polarizing lens and the second polarizing lens are different.

18. An active optical element, comprising:
a first substrate;
a second substrate, top-bottom opposed with the first substrate;
a first electrode structure layer, disposed on the first substrate, and the first electrode structure layer comprising a plurality of first electrodes, a plurality of second electrodes alternately arranged with the first electrodes, and a first insulating layer located between the first electrodes and the second electrodes, wherein the first electrodes and the second electrodes are extended along a first direction, and a first gap being formed between two adjacent second electrodes, while an area of each of the first electrodes fills one corresponding first gap;
a second electrode structure layer, disposed on the second substrate; and
a liquid crystal layer, located between the first electrode structure layer and the second electrode structure layer.

19. The active optical element of claim 18, wherein the area of each of the first electrode is larger than the first gap between the two adjacent second electrodes.

20. The active optical element of claim 18, wherein the area of each of the first electrode is equal to the first gap between the two adjacent second electrodes.

21. The active optical element of claim 18, wherein the second electrode structure layer comprises a plurality of third electrodes, a plurality of fourth electrodes alternately arranged with the third electrodes, and a second insulating layer located between the third electrodes and the fourth electrodes, wherein the third electrodes and the fourth electrodes are extended along a second direction intersected with the first direction, and a second gap is formed between two adjacent fourth electrodes, while an area of each of the third electrodes fills one corresponding second gap.

22. The active optical element of claim 21, wherein the area of each of the third electrodes is larger than the second gap between the two adjacent fourth electrodes.

23. The active optical element of claim 21, wherein the area of each of the third electrodes is equal to the second gap between the two adjacent fourth electrodes.
